(19) United States
(12) Patent Application Publication
(10) Pub. No.: US 2008/0127277 A1
(43) Pub. Date: May 29, 2008

(54) NETWORKED DIGITAL TUNERS

(75) Inventor: Brian Kuschak, Sunnyvale, CA (US)

Correspondence Address: DVA/PIONEER RESEARCH CENTER USA, INC., 2265 E. 220TH STREET, LONG BEACH, CA, 90810, US

(73) Assignee: PIONEER RESEARCH CENTER USA, INC., San Jose, CA (US)

(21) Appl. No.: 11/532,377

(22) Filed: Sep. 15, 2006

(51) Int. Cl. H04N 7/173

(52) U.S. Cl. 725/74

(57) ABSTRACT

A network bridging system, which receives RF (radio frequency) broadcast digital audio/video and encapsulates and routes selected broadcast content across a Local-Area-Network (LAN). The system includes multiple tuners that allow multiple client devices to access the broadcast content simultaneously through a network connection. It serves as a standalone Ethernet server and does not require a connection to a PC. The broadcast content, encapsulated in unicast or multicast network packets, is shared among multiple users concurrently.

### BACKGROUND OF THE INVENTION

1. Field of the Invention

The present invention relates generally to digital video and networking, and more particularly, to a digital media to Local-Area-Network (LAN) bridge device.

2. Description of the Related Arts

Broadcast content providers are increasingly transmitting in digital format, and consumers are increasingly using multiple televisions, digital video recorders (DVRs), and multimedia personal computers (PCs) in their homes and workplaces. Furthermore, homes and workplaces are being wired to incorporate high-bandwidth category 5 (CAT-5) network cabling. However, there is no easy way to transfer and share live broadcast content on a local area network.

In the case where a single video tuner is connected to a Universal Serial Bus (USB), it is usually connected to a PC, and only is useable on that one PC. In the case of a single analog tuner that connects to an Ethernet network, the tuner needs to incorporate analog-to-digital conversion, and encode data into some kind of format. This increases the cost and decreases the quality of the content and still only allows one client user per single analog tuner.

The present invention provides a network bridging system, which encapsulates and routes selected broadcast content across a Local-Area-Network (LAN). The system includes multiple tuners that allow multiple client devices to access the broadcast content simultaneously. It acts as a standalone network server and does not require a connection to a PC. The broadcast content, encapsulated in multicast network packets, is shared among multiple users concurrently.

### SUMMARY OF THE INVENTION

The invention relates to a broadcast media to local-area-network bridge system. The system includes one or more digital television (DTV) tuners which receive incoming RF-modulated signals (such as QPSK, QAM, VSB, or COFDM) from over-the-air antennas, cable television (CATV) providers, direct-broadcast satellite antennas (DVB, DSS, etc.) and perform functions such as amplification, filtering, detection, and demodulation of digital television signals (ATSC, DVB, ISDB, DSS). The tuners then present the DTV signals in a standard digital stream format (MPEG-2 transport stream or DSS transport stream) for further processing by a microprocessor or digital logic. The microprocessor or digital logic receives the signals as separate input streams and buffers these signals to accommodate short-term differences in input/output rate, such as experienced by delays incurred in typical switched packet network physical environments (Ethernet, USB, IEEE-1394, etc.) and provides these streams to a network device interface. The network device interface transmits and receives packets of information on a common network interface (such as Ethernet, USB, or IEEE-1394). The system also includes a control algorithm to initiate and send data packets over the network device which include, as part of their payload, the content of the aforementioned streams as received from the microprocessor or buffering logic, which have been buffered, possibly modified by other algorithms (such as decryption, encryption, filtering by PID, port, or other network identifiers), grouped, and inserted into a common network protocol, (such as TCP, UDP, RTP, USB bulk or isochronous streams, or other network packet formats) for distribution over a local area network. The system further includes a controller. The controller controls the tuning parameters for each of the aforementioned individual DTV tuners, which is implemented over the network device interface as commands and responses sent in the payload of network packets, or in response to control by the microprocessor, or in response to messages contained within the streams of digital television, music, or other broadcast content received by the tuners. The announcement module provides a means of the device announcing itself to the network, either independently, or in response to a query. The ownership module allows other network devices to obtain exclusive access to one or more of the tuners, or a subset of the streams provided by one or more of the tuners, and if so provided an additional mechanism for the release of the exclusivity, activated by either the device itself, or the network device, which owns the exclusive access.

The system has the ability to receive both media (audio and video) and ancillary information (internet TCP/IP data, EPG data, content protection or conditional access information) across multiple independent tuners. Some of these tuners share a common RF input, such as US digital CATV or an over-the-air antenna. Remaining tuners each use separate dedicated RF inputs, such as direct-broadcast satellite dish antennas. RF inputs may include such sources as US CATV digital, ATSC over-the-air broadcast antennas, DVB or DSS satellite antennas, and satellite antennas for satellite-broadcast commercial radio stations audio programming, such as XM Radio or Sirius.

In one embodiment, the system controller, consists of the microprocessor and memory, along with a custom hardware logic device such as FPGA, CPLD, or ASIC, which allows multiple network client devices to gain exclusive or shared access to any of the RF tuners/demodulators. Each of the network clients can discover the existence of the device and its particular capabilities, using an industry standard network protocol, such as UPNP (Universal Plug-n-play). The clients instruct the device to tune to a particular TV channel, specified as a set of RF parameters such as frequency, modulation, code rate, symbol rate, bandwidth, etc, or to a known channel from which the RF parameters can be determined. They can instruct the device to filter each stream to pass or block certain packet types coming from the broadcaster (such as MPEG-2 PIDs or DVB tables.) The controller divides this filtered stream into segments, consisting of an integral number of packets from the broadcast streams, which can be accommodated by the packet size of the underlying network protocol, and inserts them into packets sent out over the network interface. The packets can be sent as unicast packets, such that only one other network device will see them, or as broadcast packets, such that all local network devices will receive them, or as multicast packets, such that only a subset of the local network devices will receive them.

The client devices typically use these streams by decoding them and presenting the resulting video and audio to a consuming device (such as a television, multimedia PC, or DVR). On a local area network, such as those found in residential homes, offices, or commercial businesses, multiple users might be watching television in different rooms on different devices. One room might have a plasma TV, another an LCD TV, another a multimedia PC, and another room might have a DVR recording the live television content provided by the device over the network. Instead of each user needing a complete television receiver including the tuner, demodulator, filters, conditional access module, etc., they may use a simpler device, which has a network interface. In addition, instead of wiring coaxial cable into all the rooms where content is consumed, CAT-5 network cabling which is already commonly installed in new homes and offices, is used to carry television and audio content in addition to the existing conventional network traffic. The system can be placed in a location suitably close to the point of entry of digital media coaxial cabling for the building. Power for the device is also provided over the network interface using an industry standard power-over-LAN power source. This results to a single cable to connect to the local area network and power the device.

The system also includes the integration of one or more industry-standard Conditional Access Module card slots, such as CableCARD or DVB-CI, to descramble authorized content. To protect this descrambled content from unauthorized reception on the LAN, the system uses an industry-standard Digital Rights Management system, such as DTCP-IP or Windows DRM, to secure data as it is sent over the LAN. The CAM removes the encryption that the broadcast content provider has applied. The system then re-encrypts this data for transmission over the LAN. Only authorized LAN clients can decrypt this content, using methods well known to those skilled in the art.

It is noted that the Digital Transmission Content Protection over Internet Protocol (DTCP-IP) is a specification for copy protection of copyrighted content that is transferred over digital interfaces in home networks that adhere to IP. Under this specification, digital content can be shared securely between devices in a user's home but not shared with other users outside the home network. The DTCP-IP uses an authentication scheme to allow user to designate devices in the home network as trusted destinations that can transfer/share data.

Windows Media digital rights management (DRM) is a flexible platform that makes it possible to protect and securely deliver content by subscription or individual request for playback on a computer, portable device, or network device. It is noted that the DTCP-IP and the Windows DRM specifications may be found in the sites listed below: http://www.dtcp.com/—Digital Transmission Licensing Administrator http://www.microsoft.com/windows/windowsmedia/forpros/drm/faq.aspx—Windows Media DRM.

### BRIEF DESCRIPTION OF THE DRAWINGS

FIG. 1 is a block diagram illustrating a digital video to local-area-network (LAN) bridge system in which one embodiment of the present invention can be practiced.

FIG. 2A is a block diagram illustrating the control algorithms and data processing algorithms in which one embodiment of the present invention may be practiced.

FIG. 2B is a block diagram illustrating data and control flow through the LAN bridge system in which one embodiment of the present invention can be practiced.

FIG. 3 is a block diagram illustrating a circuit board for the LAN bridge system in which one embodiment of the present invention can be practiced. Individual tuner modules are chosen to support the digital media formats in use in a particular region, such as VSB and QAM in USA, DVB in Europe, or ISDB in Japan. Smart Card or CableCard CAM modules are chosen, depending on the region and service provider implementation.

FIGS. 4A and 4B are block diagrams illustrating a Field-Programmable Gate-Array (FPGA) circuit in which one embodiment of the present invention may be practiced.

FIGS. 5A, 5B, 6-10, are flowchart diagrams illustrating the processing of control messages in which one embodiment of the present invention can be practiced.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, software, firmware, microcode, or any combination thereof. When implemented in software, firmware, or microcode, the elements of the embodiment of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the machine accessible medium include an electronic circuit, a semiconductor memory device, a read-only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc. The program, code, etc. may be embedded in a processor of any device that can store and process the code.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

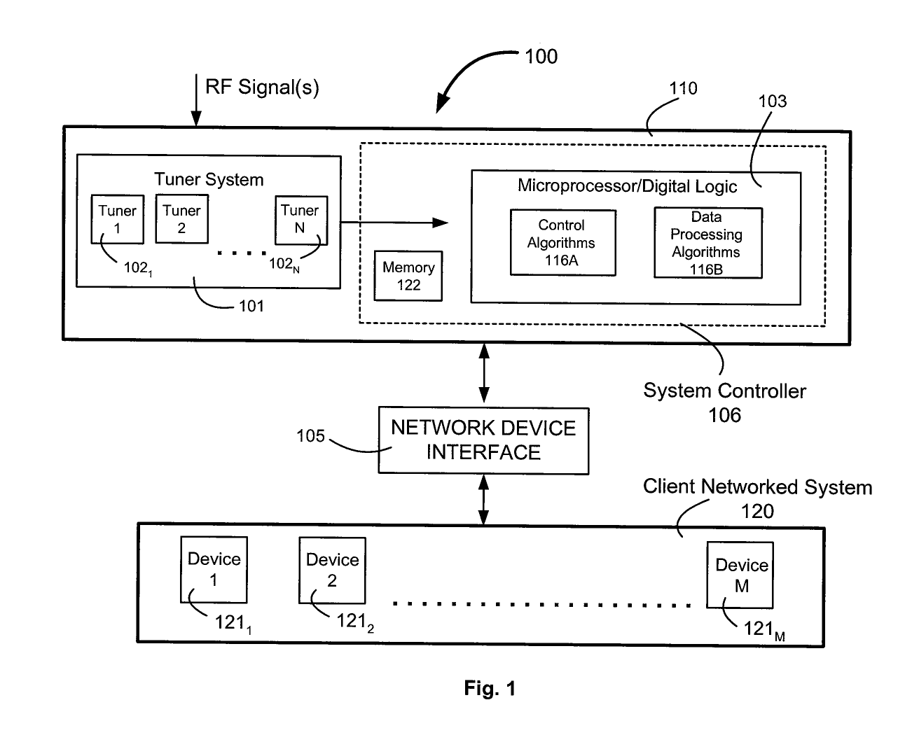

FIG. 1 is a block diagram illustrating a digital video to local-area-network (LAN) bridge system 100 in which one embodiment of the present invention can be practiced. The LAN bridge system 100 comprises a networked high bandwidth digital tuner system 110, which includes a set of standard digital video tuners 101, a system controller 106, which includes a memory 122 and a microprocessor/digital logic 103, a network device interface 105, and a client networked system 120, which includes client devices 121₁ to 121_{M} (“M” being a positive whole number) The tuner system 101 includes tuners 102₁ to 102_{N} (“N” being a positive whole number). The microprocessor/digital logic includes control algorithms 116A, data processing algorithms 116B (i.e., decryption, encryption, filtering by PID, etc.). Detailed description on these devices is described below.

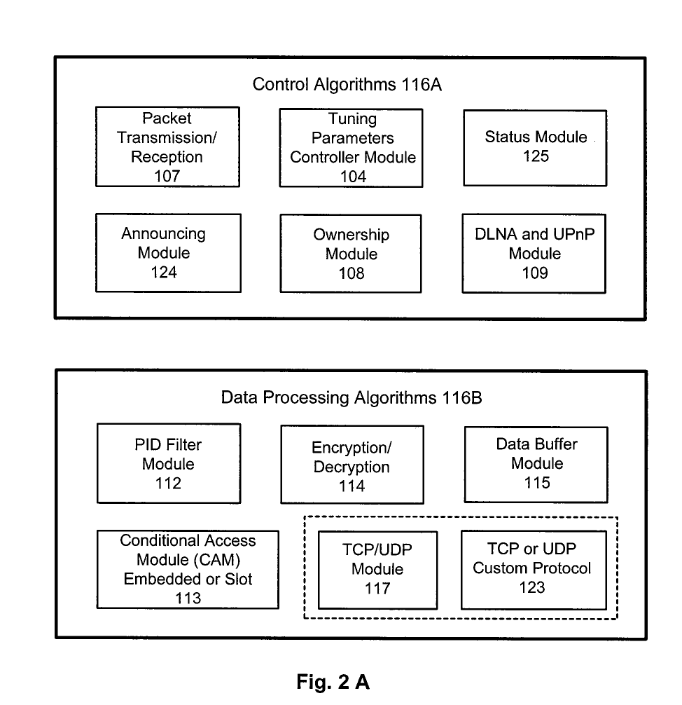

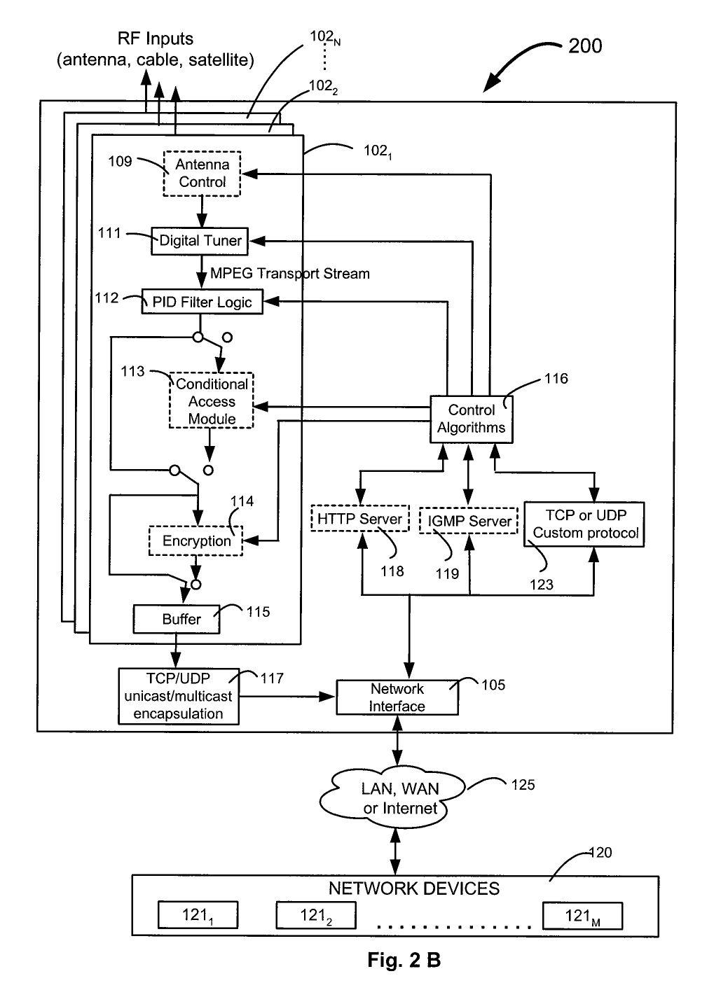

FIGS. 2A and 2B is a block diagram illustrating the control algorithms and data processing algorithms, and internal data and control paths in the LAN bridge system 100, respectively in which one embodiment of the present invention may be practice. As to FIG. 2A, the control algorithms 116A includes a packet transmission/reception module 107, a tuning control module 104, a status module 125, an announcing module 124, an ownership module 108, and a DLNA UPnP module 109. The data processing algorithms 116B includes a PID filter logic module 112, an encryption/decryption module 114, a data buffer module 115, a conditional access module (CAM) 113 and a TCP/UDP module 117 and a TCP or UDP Custom protocol 123. Detailed description of these modules is described below.

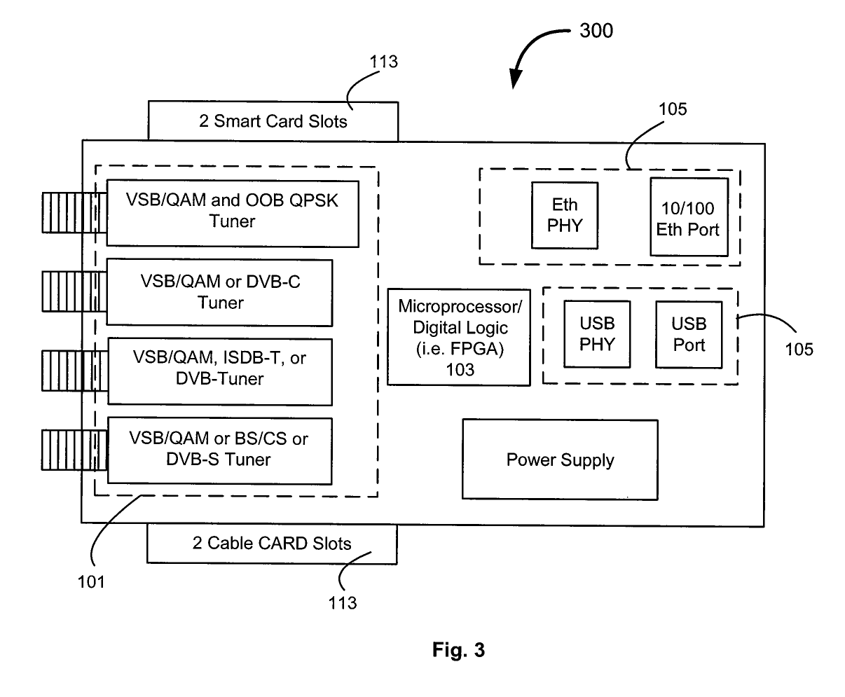

As to FIG. 2B, each tuner 102₁ to 102_{N} in the networked tuner system 101 includes the optional antenna control module 109, digital tuner module 111, the PID filter logic 112, the Conditional Access Module (CAM) or CAM slot 113, the encryption/decryption module 114, and the data buffer module 115. The microprocessor 103, which includes the control algorithms module 116A, and further includes a Hyper Text Transfer Protocol (HTTP) server module 118, an Internet Group Management Protocol (IGMP) server module 119, a Transmission Control Protocol (TCP) or User Data Protocol (UDP) (i.e., custom protocol) 123, and the TCP/UDP unicast/multicast encapsulation module 117. The network device interface 105 provides a communication between the networked high bandwidth digital tuner system 110 and the client networked system 120 via a LAN, WAN, or Internet. It is noted that the algorithms such as the PID filter logic module 112, the CAM 113, the Encryption/Decryption module 114, etc. may be implemented by hardware, software, etc. or any combination thereof and/or may be on the same board as the networked tuner system 101 or the microprocessor digital logic 103. When implemented by software/microcode, these algorithms may be processed by the microprocessor 103. FIG. 3 is a block diagram illustrating a circuit board for the LAN bridge system in which one embodiment of the present invention can be practiced. The tuner board 300 includes four digital television tuners (VSB/QAM and OOB QPSK, a VSB/QAM or DVB-C, VSB/QAM, ISDB-T, or DVB-T, a VSB/QAM or BS/CS or DVB-S), an Ethernet physical interface (10/100 Mbps PHY), FPGA for custom digital logic, USB physical interface (PHY), USB port, a power supply, Smart Card slots, and CableCARD slots. The networked tuner board 300 is a high-bandwidth, digital tuner system that can be shared among multiple clients (i.e., devices 121₁ to 121_{N}) to provide multi-channel digital video and audio. The networked tuner board 300 includes multiple hardware tuners that simultaneously tune any combination of RF channels (i.e., VSB/QAM, DVB, etc.) to receive multiple High Definition (HD) channels and/or Standard Definition (SD) channels simultaneously. The networked tuner board 300 also supports wideband tuners, which can tune multiple channels at once. The hardware of the networked tuner board 300 is designed to allow support for all major worldwide digital formats. The tuner stuffing options allow support for USA cable/terrestrial (VSB, QAM), European cable/terrestrial (DVB-C, DVB-T) and Japan terrestrial/satellite (ISDB-T, ISDB-S), as well as worldwide DVD-S satellite.

Tuners: The set of digital video tuners 101 includes tuners 102₁ to 102_{N} (i.e., digital television (DTV) tuners). Each tuner 102₁ to 102_{N} in the networked tuner system 101 receives incoming radio frequency (RF)-modulated signals. These signals may be modulated with any of a variety of commonly used digital modulation formats, such as Quadrature Phase Shift Keying (QPSK), Quadrature Amplitude Modulation (QAM), Vestigial Side Band (VSB) (an analog modulation technique), and Code Orthogonal Frequency Division Multiplexing (COFDM), etc. These signals are received from over-the-air terrestrial antennas, cable television (CATV) providers, direct-broadcast satellite antennas (i.e., digital video broadcast (DVB), digital satellite system (DSS), etc.). The tuners 102₁ to 102_{N} in the networked tuner system 101 perform functions such as amplification, filtering, detection, and demodulation, of digital television signals (i.e., Advanced Television System Committee (ATSC), Digital Video Broadcast (DVB), Digital Signal Standard (DSS), Integrated Services Digital Broadcast (ISDB), etc.). The tuners 102₁ to 102_{N} in the networked tuner system 101 then present the Digital Television (DTV) signals in a standard digital stream format such as Moving Picture Experts Group (i.e., MPEG-2) transport stream; DSS transport stream, etc., for further processing by the microprocessor and/or digital logic 103. The multiple tuners 102₁ to 102_{N} simultaneously tune any combination of multiple RF channels to demodulate multiple HD channels or multiple SD channels simultaneously. They also support wideband tuners (i.e., Silicon Tuners), which can tune multiple channels at once. The networked tuner system 101 supports all major worldwide digital formats. The networked tuner system 101 includes tuner stuffing options that allows support for USA cable/terrestrial (QAM, VSB), European cable/terrestrial (DVB-C, DVB-T), and Japan terrestrial/satellite (ISDB-T, ISDB-S), as well as worldwide DVB-S satellite. For use in the U.S., the formats implemented are VSB, QAM, DVB-S and XM radio. For use in Japan, the formats implemented are ISDB-T and BS/CS satellite. As for use in Europe, the formats implemented are DVB-C, DVB-T, and DVB-S. The CAM or CAM slots used in the U.S. may be Single Stream CableCARD, Multistream CableCARD, and/or DVB-CI cards and in Europe, DVB-CI card. The Smart Card used in Japan may be a B-CAS card. In one embodiment, the system 110 includes Satellite tuners 102₁ to 102_{N} that have the capability to send special control messages from the antenna control module 109 down the signal cable to the Satellite LNB. These control messages are used to select satellite switch positions, drive a motor, or do a number of other things to the satellite front end. These messages, along with DC voltage and audio tone, are described in the DiSEqC specification (i.e., a copy of the specification may be obtained from EUTELSAT S.A. 70 rue Balard, F-75502 PARIS CEDEX 15, FRANCE or at the Eutelsat website, http://www.eutelsat.com/satellites/4_{—}5_{—}5.html). In the preferred embodiment, system 110 supports unidirectional DiSEqC version 1.2. It supports 13V or 18V polarization control, tone-burst, continuous tone, and modulated messages. These features can be used to point a motorized satellite dish, or select among multiple LNB antennas.

Microprocessor/digital logic: The microprocessor/digital logic 103 performs overall control of the system 100. It receives the transport stream signals from the individual tuners as separate input streams and buffers these streams to accommodate short-term difference in input/output rate, such as experienced by delays incurred in switched packet network physical environments (i.e., Ethernet, USB, IEEE 1394, etc.), enables any data processing algorithms 116B and provides the streams to the network interface 105.

Control algorithms: The control algorithms 116A which run on the microprocessor 103 receive control packets from client devices and send responses to these control packets. These packets allow client devices to control the operation of the system, commanding such things as tuning; stream filtering (allowing or blocking certain MPEG-2 Packet IDs), encryption/decryption, and obtaining status of the system. Client devices may also communicate with the control algorithms 116A to control the IP address(es) or multicast group address(es) to which the streams are sent. The control algorithms 116A also allow client devices to obtain exclusive access to one or more of the tuners in the tuner system 101 or a subset of the streams provided by one or more of the tuners and an additional mechanism for the release of the exclusivity. If exclusive access is given to a client device, a mechanism is provided to allow this exclusive access to expire if the client is disconnected from the network or otherwise unexpectedly stops responding. In the case where the requested tuner is not already allocated, the request is successful and the requesting client device has the exclusive control over that tuner. The client device may later release its exclusive ownership of that tuner. This ownership may be forcefully revoked in some cases, such as when the client device unexpectedly loses connectivity (i.e., it crashes, or experiences power failure), or if another higher priority device claims exclusive control. The control algorithms 116 control the tuning parameters for each of the tuner modules 102₁ to 102_{M}. The control algorithms 116 allows the client devices to send/receive command and/or responses in the payload of network packets or in response to control by the microprocessor 103, or in response to messages contained within the streams of digital television, music, or other broadcast content received by the tuners 102₁ to 102_{N} in the networked tuner system 101. The client networked system 120 is allowed to obtain exclusive access to one or more tuners or a subset of the streams provided by one or more tuners. The networked high bandwidth digital tuner system 110 also provides mechanisms to the client networked system 120 for the release of the exclusivity, activated by either the tuner system itself or one or more client devices in the client networked system 120 which owns the exclusive access. The control algorithms also provide a mechanism for the device to announce its presence and capabilities to client devices 120 on the network. Control algorithms 116B, may support multiple different kinds of control packet protocols. In one embodiment, the following minimal set of simple UDP/IP control packets (see table below) allows for a simple implementation, without using a more complex industry standard protocol such as UPNP. In one embodiment, to simplify system implementation, all control packets from the client devices are sent to fixed multicast IP addresses. By using multicast addresses, there is no need to perform Address Resolution Protocol (ARP) requests or replies. (The destination MAC address of multicast packets is determined directly from the multicast IP address.)

Table UDP/IP shows a list of UDP/IP commands in which one embodiment of the present invention can be practice.

Packets IN to Network Tuner System

| | |
|---|---|
| TUNNER_INITIALIZE | (Re)initialize tuner with sane |
| | defaults |
| TUNE CHANNEL | Attempt to lock to a channel |
| TUNER_STATUS | Get lock status from tuner |
| READ_PID FILTER | Read the PID filter registers |
| WRITE_PID_FILTER | Write the PID filter registers |
| TUNER_SLEEP | Put tuner into low-power shutdown |
| | mode |
| DISEQC | Send DiSEqC message, voltage, or tone |
| | burst to satellite front end |
| WRITE_CARD | Write data to CAM card (CableCard, |
| | DVB-0CI, etc. |
| READ_CARD | Read data from CAM card |
| CARD_STATUS | Get status of the CAM card |
| I2C_READ | Raw I2C read |
| I2C_WRITE | Raw I2C write |
| SEMAPHORE_CTL | Acquire or release a semaphore |
| FIRMWARE_UPDATE | Program flash for FPGA or |
| | microcontroller |

Packets OUT from Network Tuner System

| | |
|---|---|
| HELLO | Periodic announcement of device and |
| | capabilities |
| TUNER_STATUS_RESP | Response for tuner status |
| READ_PID_FILTER_RESP | Response for PID filter read |
| I2C_READ_RESP | Response for I2C read data |
| READ_CARD_RESP | Response returning READ_CARD data |
| MPEGTS | MPEG-TS packets from one tuner with |
| | small header |
| MPEGTS_UDP | MPEG-TS packets with no additional |
| | headers |
| MPEGTS_RTP | MPEG-TS packets with an |
| | RTP-compliant header |
| SEMAPHORE_RESP | Response to a semaphore operation |

Data processing algorithms: The data processing algorithms 116B include decryption, encryption, and filtering by PID (MPEG-2 packet identifier). The data processing algorithms 116B extract selected MPEG-2 transport stream packets from the broadcast streams, and insert them into a common network protocol (i.e., TCP, UDP, RTP, USB bulk or isochronous streams, or other network packet formats) for distribution over a local-area-network. Each tuner 102₁ to 102_{N} in the networked tuner system 101 has its own PID filter logic (i.e.,

112). In one embodiment, the PID filter is a 1 bit by 8192 bit block RAM. If a bit is set, the corresponding PID is accepted and continues to the next module, otherwise it is dropped. Alternatively, the PID filter can be designed to accept a subset of PIDs, rather than all 8192 PIDs. In one embodiment, using separate IP multicast addresses for the data from each tuner 102₁ to 102_{N} allows clients (i.e. devices 121₁ to 121_{M}) to exploit the hardware filtering capability of Ethernet cards. Sending multicast content this way allows multiple clients to receive content simultaneously, without flooding non-participating clients with undesired packets.

Network interface: The communication between the system 110 and the client devices 121₁ to 121_{M} in the client networked system 120 is implemented over the network device interface 105. The client devices 121₁ to 121_{M} may instruct the networked high bandwidth digital tuner system 110 to tune to a particular set of RF parameters (i.e., frequency, modulation, code rate, symbol rate, bandwidth, etc.), or to a known channel from which the RF parameters can be determined. The client devices 121₁ to 121_{M} may also instruct the networked high bandwidth digital tuner system 110 to filter each stream to pass or block certain packet types coming from the broadcaster (i.e., MPEG-2 PIDs or DVB tables, etc.) The filtered packets may then be optionally modified by data processing algorithms such as the CAM, or encryption/decryption. The TCP/UDP encapsulation module 117 divides the filtered stream into segments, consisting of an integral number of packets from the broadcast streams, which can be accommodated by the packet size of the network protocol, and inserts them into packets sent out over the network interface 105. The packets use a common network protocol (i.e., Transmission Control Protocol (TCP), User Datagram Protocol (UDP), Real-time Transport Protocol (RTP), Universal Serial Bus bulk or isochronous streams, or other network packet formats) for distribution over the LAN/WAN or Internet 125. The packets are sent as unicast packets, such that only one other network device sees them or as broadcast packets, such that all local network devices receive them, or as multicast packets, such that only a subset of the local network devices 121₁ to 121_{M} receives them. For some applications, a USB interface may be used instead of an Ethernet interface. In one embodiment, the system can have both USB and Ethernet interfaces, and use the appropriate one, based on which cable (USB or Ethernet) is connected to the device. If a USB interface is used, the streams may be encapsulated into bulk or isochronous packets as are typically used in USB, rather than using TCP/IP encapsulation as used by Ethernet.

Client Networked System: The client devices 121₁ to 121_{M} use these streams by storing them, or decoding them and presenting the resulting video and/or audio to a consuming device. Examples of client devices are television, personal video recorder (PVR), personal computer (PC), etc. For example, on a local-area-network, such as those found in residential homes, offices, or commercial businesses, multiple users are watching television in different rooms on different devices, one room may have a plasma TV, another an LCD TV, another a multimedia PC, and another room may have a DVR recording the live television content provided by the device over the network. Instead of each user requiring a complete television receiver including a tuner, demodulator, filters, conditional access, etc., they may use a simpler device, which has a network interface. In addition, instead of wiring coaxial cable into all the rooms where content is consumed, a common network cabling which is already commonly installed in homes and offices, is used to carry television and audio content in addition to the existing conventional network traffic. The networked high bandwidth digital tuner system 110 can be placed in a location suitably close to the point of entry of digital media coaxial cabling for the building. In one embodiment, power for the networked high bandwidth digital tuner system 110 is provided over the network interface 105 using an industry standard power-over-LAN power source. This leads to a single cable to connect to the local-area-network and power the device.

In one embodiment, the microprocessor 103 includes a system controller, a memory, a custom logic (i.e., FPGA, CPLD, ASIC, etc.). The control algorithms are implemented in hardware, software, or any combination thereof. These control algorithms run on the system controller. The system controller has a connection to the network interface (i.e., Ethernet and/or USB) over which it sends and receives packets. The system controller also connects to each of the tuners 102₁ to 102_{N} in the tuner system 101.

As stated above, the LAN bridge system 100 includes the networked, high bandwidth, digital tuner system 101 that can be shared among multiple clients (i.e., devices 121₁ to 121_{M}) to provide multichannel high definition (HD) and/or standard definition (SD) video and audio, the microprocessor or digital logic 103, the network device interface 105, the TCP/UDP unicast/multicast encapsulation module 117, and the client networked system 120 which includes plurality of devices 121₁ to 121_{M}. The network interface 105 interacts with the client networked system 120 via LAN, WAN, and/or Internet. The system 100 is expandable by adding more units to a Local Area Network (LAN).

Below shows the summary capabilities of the networked tuner board.

| | |
|---|---|
| Formats | USA ATSC terrestrial - VSB8 at 19.6 Mbps |
| | USA OpenCable - QAM64, QAM256 up to |
| | 38 Mbps + OOB |
| | Japan ISDB-T - OFDM at 20 Mbps |
| | Japan BS/CS satellite - 8PSK up to 30 Mbaud |
| | Europe DVB-T - COMM |
| | Europe DVB-C - QAM64/QAM256 |
| | Worldwide DVB-S - QPSK at up to 30 Mbaud |
| Tuners | Up to 4 |
| Tuner interface | serial or 8-bit parallel MPEG-TS into FPGA |
| Conditional | Supporting CableCARD, Multistream CableCARD, |
| Access | DVB-CI card, ISO7816 smart card (B-CAS) |
| Connectivity - | 10/100 Mbps Ethernet full/half duplex |
| | Unicast or Multicast TCP/UDP/IP for command and data |
| | UPnP and DLNA support |
| | (or USB 2.0 High Speed alternative) |
| Data rate | For 100 Mbps Ethernet: |
| | Up to 88 Mbps MPEG-TS data rate. |
| Tuner control | Simple UDP/IP packet protocol or UPnp/DLNA |
| LNB control | 13 V/18 V at 500 mA max |
| (satellite inputs | DiSEqC 1.2 with 22 KHz modulated tone |
| only) | 44 KHz Japan BS/CS control |
| Power input - | 10 VDC to 16 VDC @ 2.5 A |
| Indicator LEDs | Power |
| | Lock/data on each tuner |
| | Ethernet link/activity |

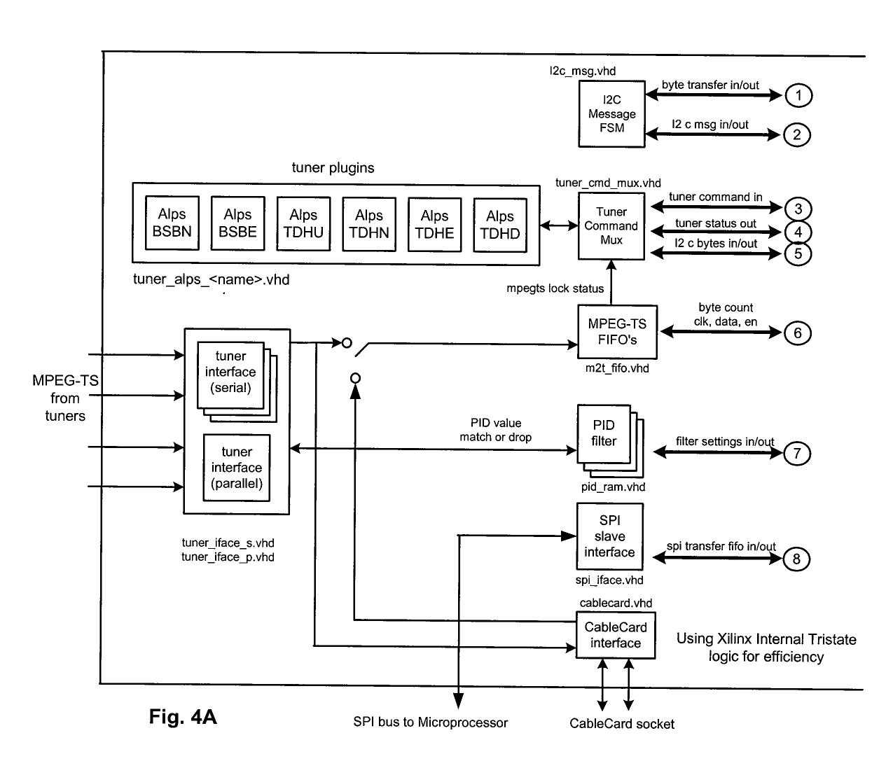

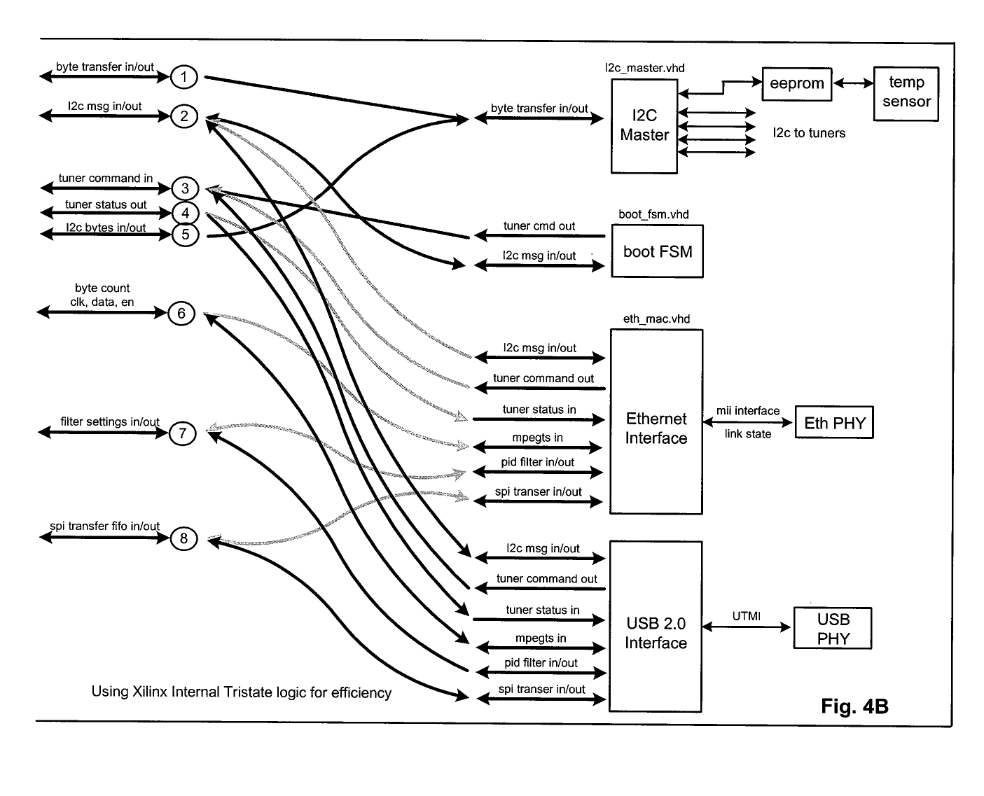

FIGS. 4A and 4B are block diagrams illustrating a Field Programmable Gate-Array (FPGA) circuit in which one embodiment of the invention can be practiced. The FPGA block diagram circuit includes plurality of tuner plugins, serial tuner interface, parallel tuner interface, I2C Message finite state machine, Tuner Command Multiplexer, MPEG-TS (First In, First Out) FIFOs, PID filter, Serial Peripheral Interface (SPI) slave interface, CableCard interface, I2C Master, boot finite state machine (FSM), Ethernet interface and USB interface. The I2C Master communicates with tuners and EEPROM; the Ethernet interface communicates with the Ethernet physical interface (PHY) and the USB interface communicates with the USB PHY.

In one embodiment, the networked high bandwidth digital tuner system 110 is interoperable with other consumer electronic devices, by conforming to Digital Living Network Alliance (DLNA) guidelines and requirements. This makes the system 100 interoperable with a large number of client devices 121₁ to 121_{M}. For DLNA compliance, there are several components included in the system 110. These components include:
Support for TCP/IP, HTTP, and Extensible Markup Language (XML)
Support for Simple Object Access Protocol (SOAP)
DHCP client and AutoIP
Address Resolution Protocol (ARP), Internet Control Message Protocol (ICMP)

These components are implemented in the microprocessor/digital logic 103 by software, hardware or any combination thereof. In one embodiment a combination of software and hardware is used. The hardware includes a sufficiently powerful microcontroller or microprocessor 103 to run the DLNA software stack. The system 110 is exposed as a DLNA media server, using the “Tuner Representation” object, as specified in the DLNA Home Networking v1.0 specification (available from the DLNA website at http://www.dlna.org.). The Content Directory Service is used to expose a channel lineup using a physical channel map or information from MPEG-2 tables in order to construct a descriptive list of channels, subchannels, station identifiers, etc.

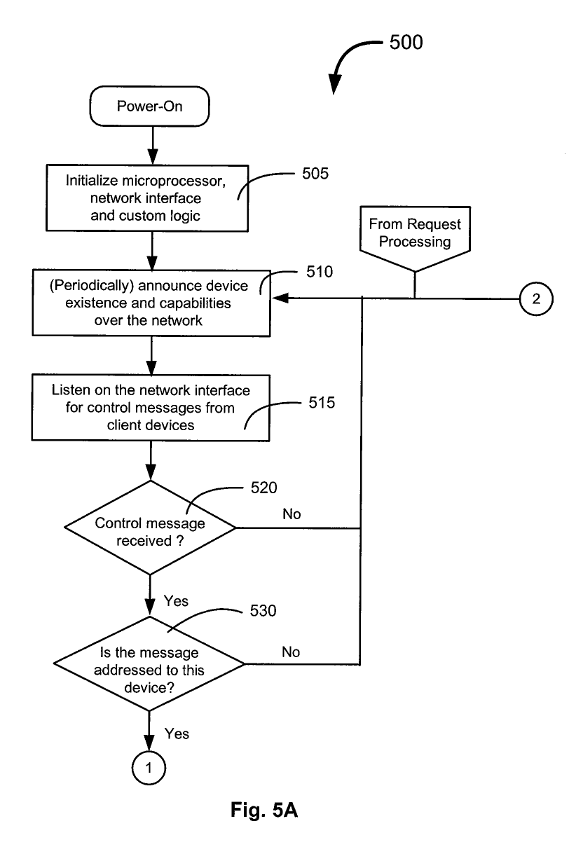

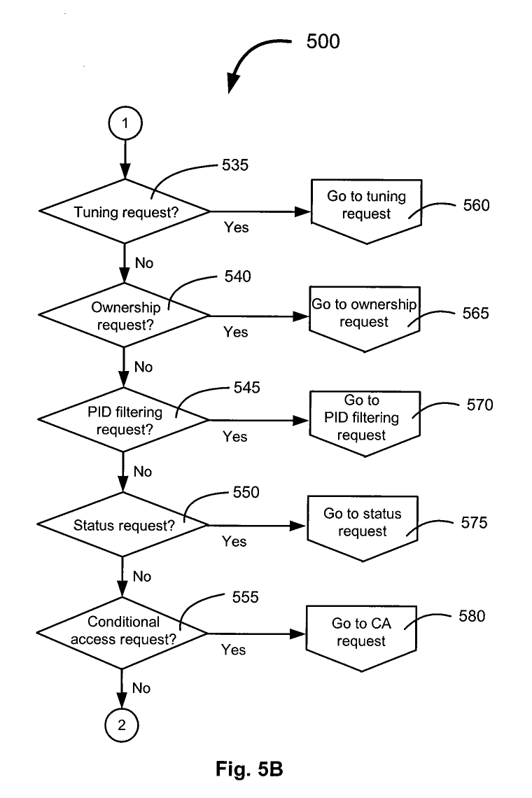

FIGS. 5A and 5B illustrates a flowchart of system operation in which one embodiment of the present invention can be practiced. The process 500 starts out at power on. The process initializes microprocessor, network interface, and custom logic at step 505. After the initialization step, the process 500 announces device existence and capabilities over the network via the network interface at step 510. The process 500 continues at step 515 to listen or monitor on the network interface for control message from client devices. At step 520, the process 500 determines whether a control message is received. If no, the process 500 goes back to step 510. Otherwise, the process 500 continues with step 530 to determine whether there is any message addressed to the device. If no, the process 530 goes back to step 510. If yes, the process 500 determines whether there is a tuning request at step 535. If yes, the process continues and goes to tuning request at step 560 (FIG. 5B). Otherwise, the process 500 continues with step 540. At step 540, the process 500 determines whether there is an ownership request. If yes, the process 500 goes to ownership request at step 565. If no, the process 500 continues at step 545 to determine whether there is a PID filtering request. If yes, the process 500 goes to PID request at step 570. Otherwise, it goes to determine whether there is a status request. If yes, the process goes to status request at step 575. If no, the process continues with step 555 to determine whether conditional access request is present. If the CA request is present, the process goes to the CA request at step 580. Otherwise, the process 500 goes back to step 510 to announce the existence of the device and its capabilities over the network. The announcing of device existence and capabilities over the network is done periodically. The process 500 continues at step 510 and so on.

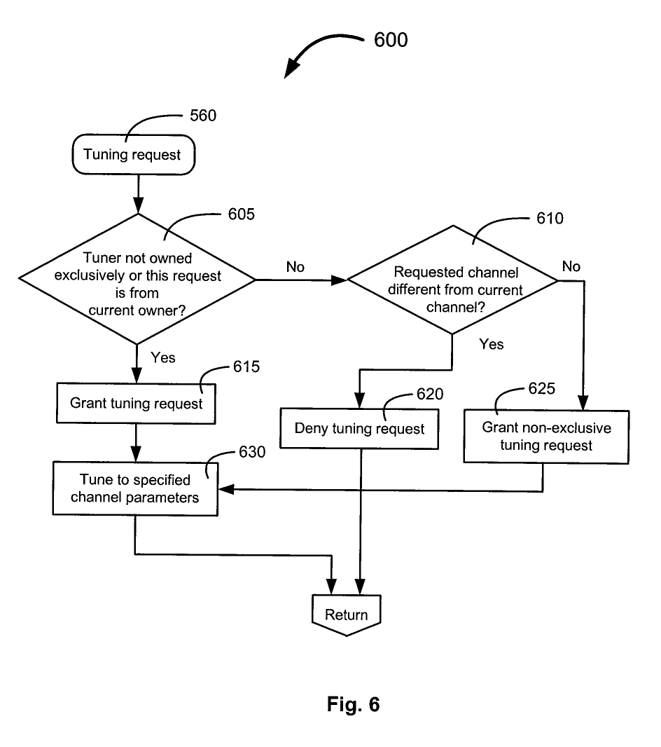

FIG. 6 illustrates flowcharts of a tuning request in which one embodiment of the present invention can be practiced. Step 560 goes to tuning request continues at step 605 to determine whether the tuner is not owned exclusively or whether the request is from the current owner. If the tuner is not owned exclusively or the request is from the current owner, the process continues with step 615 where the tuning request is granted. The process then proceeds to tune to specified channel parameters and then the process is terminated. Otherwise, the process continues with step 610 where it is determined whether the requested channel is different from the current channel. If the requested channel is different from the current channel, the process denies the tuning request at step 620 and the process is terminated. If the request channel is the same as the current channel, then at step 625, a non-exclusive tuning request is granted. The process is continued at step 630 to tune to specify channel parameters and the process is terminated.

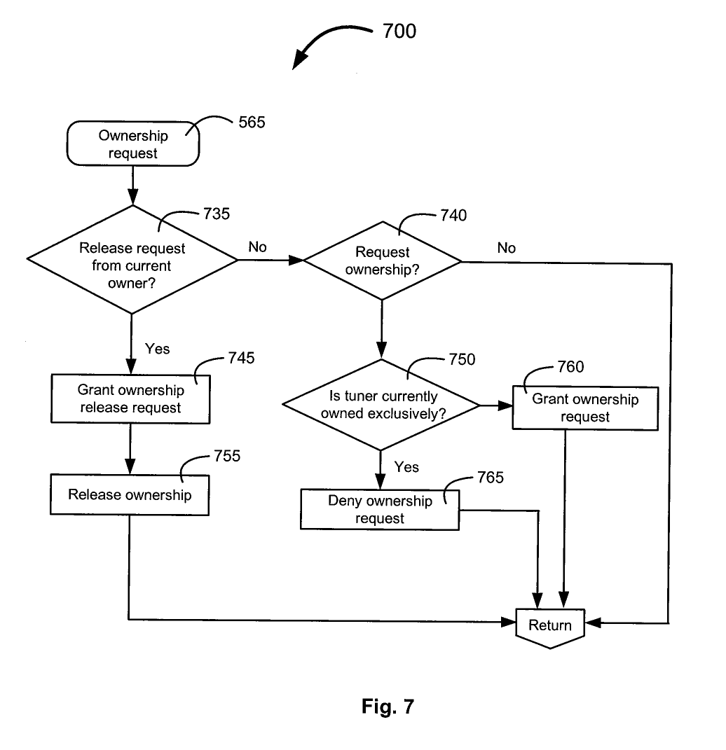

FIG. 7 illustrates flowcharts of an ownership request in which one embodiment of the present invention can be practiced. Step 565 goes to ownership request. The process then continues at step 735 to determine whether the request release is from current owner. If yes, the process proceeds to step 745 to grant ownership release request and then release ownership at step 745 before the process is terminated. If no, the process determines whether there is a request ownership at step 740. If no, the process is terminated. Otherwise, the process proceeds to step 750 to determine whether the tuner is currently owned exclusively. If yes, the process denies ownership request at step 765 before the process is terminated. If no, the process grants ownership request. The process is then terminated.

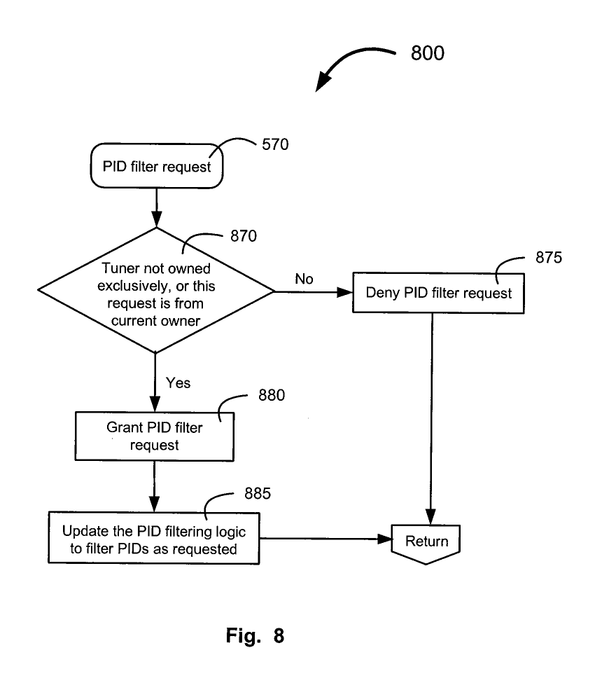

FIG. 8 illustrates flowcharts of a PID filter request in which one embodiment of the present invention can be practiced. At step 570, the process goes to PID filter request. The process then proceeds with step 870 to determine whether the tuner is not owned exclusively or whether the request is from current owner. If the owner is not owned exclusively or the request is from the current owner, the process grants PID filter request at step 880 and proceeds to update the PID filtering logic to filter PIDs as requested before the process is terminated. If not, the process denies PID filter request at step 875 before the process is terminated.

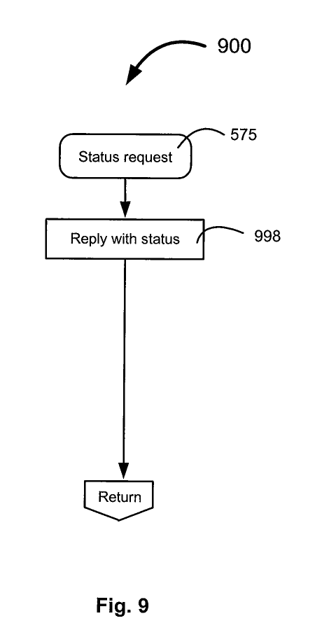

FIG. 9 illustrates flowcharts of a status request in which one embodiment of the present invention can be practiced. At step 575, the process proceeds with the status request. The process replies with the status at step 998 before the process is terminated.

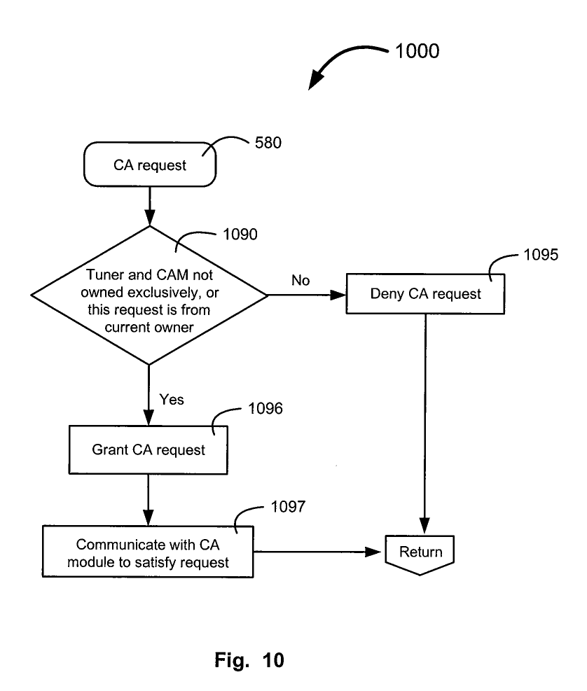

FIG. 10 illustrates flowcharts of a CA (Conditional Access) request in which one embodiment of the present invention can be practiced. At step 580, the process proceeds to CA request. The process determines whether the tuner and CAM is not owned exclusively or the request is from the current owner at step 1090. If no, the process denies CA request at 1095 and then the process is terminated. If yes, the process grants CA request at step 1096. The process continues with step 1097 to communicate with CA module to satisfy request. The process is then terminated.

While certain embodiments are illustrated in the drawings and have been described herein, it will be apparent to those skilled in the art that many modifications can be made to the embodiments without departing from the invention concepts described.

What is claimed is:

1. An apparatus comprising:
a data processing algorithm for processing radio frequency (RF) signal received from at least one tuner in a tuner system and presenting the signal in a standard format; and
a control algorithm for controlling communication between the at least one tuner and a client network system via network device interface.

2. The apparatus of claim 1 wherein the control algorithm includes a tuning parameter module, the tuning parameter module receives instruction from a device in the client network system to tune to a particular channel.

3. The apparatus of claim 2 wherein the control algorithm includes an ownership module which allows a client device in the client network system to gain exclusive or shared access to the least one tuner.

4. The apparatus of claim 2 wherein the control algorithm includes a PID filter module which receives instruction from the client device to filter a stream to pass or block a certain packet type coming from a broadcaster via the tuner system.

5. The apparatus of claim 1 wherein the standard format includes a MPEG-2 Transport Stream format.

6. The apparatus according to claim 1 wherein the control algorithm includes an announcing module having a mechanism for announcing to devices in the client network system capabilities of the tuner system, both independently and in response to a query.

7. The apparatus of claim 2 wherein the client device communicates with the control algorithm over the network device interface using a command or response sent in packets.

8. The apparatus according to claim 7 wherein the packets are sent as unicast packets or multicast packets.

9. The apparatus of claim 1 wherein the received signal includes one of media and ancillary information.

10. The apparatus of claim 1 wherein the at least one tuner shares one common RF input or has a dedicated RF input.

11. The apparatus of claim 10 wherein the common RF input is one of US digital CATV or an over-the-air antenna.

12. The apparatus of claim 10 wherein the separate dedicated RF input includes a direct-broadcast satellite dish antenna.

13. A method comprising:
processing radio frequency (RF) signal received from at least one tuner in a tuner system;
presenting the signal in a standard format; and
controlling communication between the at least one tuner and a client network system via a network device interface.

14. The method of claim 13 further comprising allowing a client device in the client network system exclusive or shared access to the at least one tuner.

15. The method of claim 13 further comprising releasing an exclusivity, activated by client device in the client network system which owns an exclusive access.

16. The method of claim 13 further comprising receiving instruction from a client device in the client network system to filter a stream to pass or block a certain packet type coming from a broadcaster via the tuner system.

17. The method of claim 13 further comprising announcing to the client network system capabilities of the tuner system, both independently and in response to a query.

18. The method of claim 13 wherein the communication between the at least one tuner and the client system is using a command or response sent in packets.

19. The method of claim 18 wherein the packets are sent as unicast packets or multicast packets.

20. The method of claim 13 wherein the at least one tuner shares one common RF input or has a dedicated RF input.

21. A system comprising:
a network client device;
a network device interface;
a network tuner device; and
a microprocessor/logic device, the microprocessor/logic device comprising:
a data processing algorithms for processing radio frequency (RF) signal received from at least one tuner in a tuner system and presenting the signal in a standard format; and
a control algorithms for controlling communication between the at least one tuner and a client network system via network device interface.

22. The apparatus of claim 21 wherein the control algorithm includes a tuning parameter module, the tuning parameter module receives instruction from a device in the client network system to tune to a particular channel.

23. The apparatus of claim 22 wherein the control algorithm includes an ownership module which allows a client device in the client network system to gain exclusive or shared access to the least one tuner.

24. The apparatus of claim 22 wherein the control algorithm includes a PID filter module which receives instruction from the client device to filter a stream to pass or block a certain packet type coming from a broadcaster via the tuner system.

25. The apparatus of claim 21 wherein the standard format includes a MPEG-2 Transport Stream format.

26. An article of manufacture comprising:
a machine-accessible medium including data that, when accessed by a machine, causes the machine to perform operations comprising:
processing radio frequency (RF) signal received from at least one tuner in a tuner system;
presenting the signal in a standard format; and
controlling communication between the at least one tuner and a client network system via a network device interface.

27. The article of manufacture of claim 26 wherein the data further comprises data that, when accessed by the machine, causes the machine to perform operations comprising allowing a device in the client network system exclusive or shared access to the at least one tuner.

28. The article of manufacture of claim 26 wherein the data further comprises data that, when accessed by the machine, causes the machine to perform operations comprising releasing an exclusivity, activated by a device in the client network system which owns an exclusive access.

29. The article of manufacture of claim 26 wherein the data further comprises data that, when accessed by the machine, causes the machine to perform operations comprising receiving instruction from a device in the client network system to filter a stream to pass or block a certain packet type coming from a broadcaster via the tuner system.

30. The article of manufacture of claim 26 wherein the data further comprises data that, when accessed by the machine, causes the machine to perform operations comprising announcing to the client network system capabilities of the tuner system, both independently and in response to a query.
